(19) United States
(12) Patent Application Publication
(10) Pub. No.: US 2025/0006445 A1
(43) Pub. Date: Jan. 2, 2025

(54) ELECTROMAGNETIC RELAY

(71) Applicant: SYSTEM DESIGN CORPORATION., FUKUI (JP)

(72) Inventors: MITSUHIRO IIDA, FUKUI (JP); SHIGEO FUKUGI, FUKUI (JP)

(21) Appl. No.: 18/277,370

(22) PCT Filed: Feb. 24, 2022
(86) PCT No.: PCT/JP2022/007615

§ 371 Date: Aug. 15, 2023

(51) Int. Cl. H01H 47/22

(52) U.S. Cl. CPC H01H 47/22

(57) ABSTRACT

An electromagnetic relay exhibiting security capability that allows energization only upon receiving a relay energization-permitted instruction transmitted from the outside by a remote key or the like. The electromagnetic relay includes an electromagnetic unit having an electromagnet, and a contact unit for contacting or separating a movable contact and fixed contacts upon energization of the electromagnet. The electromagnetic relay is configured to include a control unit adapted to receive a signal from outside and after analyzing the received signal to determine based on the analysis result whether to energize the electromagnetic unit. A power source switching unit for supplying power to the control unit by selecting one or the other of, or switching between, power supplied to the electromagnetic unit and power supplied to the contact unit.

### RELATED APPLICATION

This application is a § 371 application of PCT/JP2022/007615 filed Feb. 24, 2022, which is incorporated herein by reference in its entirety.

### TECHNICAL FIELD

The present invention relates to an electromagnetic relay, more particularly to an electromagnetic relay incorporating a security feature that enables relay energization upon receiving a relay energization-permitted instruction from the outside.

### BACKGROUND OF THE INVENTION

Many variously enhanced electromagnetic relays have been devised and put to use and electromagnetic relays of diverse structures providing different functions have been developed and utilized. An electromagnetic relay is a switch triggered by application of current to some terminals of an apparatus to control passage of current to another terminal side. An electromagnetic relay is used, for example, to ensure safety and dependable operation when passing high current.

A technology related to an electromagnetic relay is found in Japanese Patent Publication No. 2017-79107A, for example. As an electromagnetic relay capable of opening and closing a contact device upon occurrence of abnormality, this publication discloses an electromagnetic relay that is equipped with a contact device having a movable contact and fixed contacts, an electromagnetic device equipped with a movable element having a coil and a movable contact, a power supply, a switch unit and a control unit and is configured to charge the power supply by power from a power main and to use the switch unit, which is inserted into a power supply path from the power supply to the coil, to open and close the power supply path.

The disclosed technology does in fact enable operation of the switch unit to open and close the switch using power from the power supply even at the time of an abnormality, but it is totally incapable of dealing with an abnormal situation such as unauthorized opening/closing of the contact device and as such cannot be deemed an adequate technology from the viewpoint of security.

A relay's abnormality response (security capability) is its ability to prevent energization and fundamentally eliminate risk of unauthorized use, and, by way of example, can be considered a capability that is effective also from the crime prevention viewpoint of protecting relay-utilizing equipment, such as automobile locking/unlocking and engine starting devices, against unauthorized operation. So a need has been felt to develop an electromagnetic relay exhibiting security capability that allows energization only upon receiving a relay energization-permitted instruction from the outside.

### PRIOR ART DOCUMENTS

### Patent Document

Patent Document 1: Japanese Patent Publication No. 2017-79107A

### OBJECT AND SUMMARY OF THE INVENTION

### Problem to be Overcome by the Invention

The present invention is directed to providing an electromagnetic relay for solving the aforesaid issue, particularly to an electromagnetic relay exhibiting security capability that enables energization upon receiving a relay energization-permitted instruction from an outside remote key or the like.

### Means for Solving the Problem

In order to achieve the aforesaid object, the electromagnetic relay according to the present invention comprises an electromagnetic unit having an electromagnet, and a contact unit for contacting or separating a movable contact and fixed contacts upon energization of the electromagnet, which electromagnetic relay is configured to comprise a control unit adapted to receive a signal from outside and after analyzing the received signal to determine based on the analysis result whether to energize the electromagnetic unit, and a power source switching unit for supplying power to the control unit by selecting one or the other of, or switching between, power supplied to the electromagnetic unit and power supplied to the contact unit, wherein the control unit comprises a signal receiving unit for receiving a signal from the external device and the electromagnetic unit is energized after the signal receiving unit determines permissibility of electromagnetic unit energization upon receiving and analyzing an energization request signal from the external device, and the power source switching unit is configured to connect to both the electromagnetic unit side terminals and the contact unit side terminals and in order to ensure supply of power to the control unit, when the electromagnetic unit side terminals are de-energized, acquires power from the contact unit side terminals and supplies the control unit with power for performing its control functions, and when the electromagnetic unit side terminals are energized, acquires power from the electromagnetic unit side terminals and supplies the control unit with power for performing its control functions.

The electromagnetic relay according to the present invention comprises an electromagnetic unit having an electromagnet, and a contact unit for contacting or separating a movable contact and fixed contacts upon energization of the electromagnet, which electromagnetic relay is configured to comprise a control unit adapted to receive a signal from outside and after analyzing the received signal to determine based on the analysis result whether to energize the electromagnetic unit, and a power source switching unit for supplying power to the control unit by selecting one or the other of, or switching between, power supplied to the electromagnetic unit and power supplied to the contact unit, wherein the electromagnetic unit comprises a latching mechanism equipped with a set coil and a reset coil and is configured so that energization of the set coil energizes the electromagnetic unit, thereby closing the contact unit, and energization of the reset coil de-energizes the electromagnetic unit, thereby opening the contact unit.

The electromagnetic relay according to the present invention comprises an electromagnetic unit having an electromagnet, and a contact unit for contacting or separating a movable contact and fixed contacts upon energization of the electromagnet, which electromagnetic relay is configured to comprise a control unit adapted to receive a signal from outside and after analyzing the received signal to determine based on the analysis result whether to energize the electromagnetic unit, and a power source switching unit for supplying power to the control unit by selecting one or the other of, or switching between, power supplied to the electromagnetic unit and power supplied to the contact unit, wherein the electromagnetic unit comprises a latching mechanism that controls open/close of the contact unit by using polarity reversal to energize/de-energize the electromagnetic unit. In addition, the electromagnetic unit and the contact unit are electrically isolated.

### EFFECTS OF THE INVENTION

Since the present invention is configured as described in detail in the foregoing, it has the following effects:
1. The provision of the control unit in the electromagnetic relay makes it possible to ensure security by controlling permissibility of electromagnetic unit energization. In addition, the provision of the power source switching unit makes it possible to switch the control unit power source between the electromagnetic unit side and the contact unit side, whereby the power source of the control unit can be established without fail.
2. The provision of the communication unit in the control unit makes it possible for the control unit to perform energization control after receiving an energization request signal from the external device, whereby security can be ensured by preventing energization in the absence of a signal from an authenticated external device.
3. The configuration of the electromagnetic unit to comprise the set coil and the reset coil enables latching and eliminates the need to constantly energize the electromagnetic unit.
4. The adoption of a configuration that controls ON/OFF (Open/Close) of the contact unit by polarity reversal of the electromagnetic unit enables latching and eliminates the need to constantly energize the electromagnetic unit.

### BRIEF DESCRIPTION OF THE DRAWINGS

FIG. 1 is a conceptual diagram of an electromagnetic relay according to the present invention.

FIG. 2 is a circuit diagram showing power source switching operation principle.

FIG. 3 is a circuit diagram of an electromagnetic relay utilizing a latching mechanism.

### DETAILED DESCRIPTION OF THE EMBODIMENTS

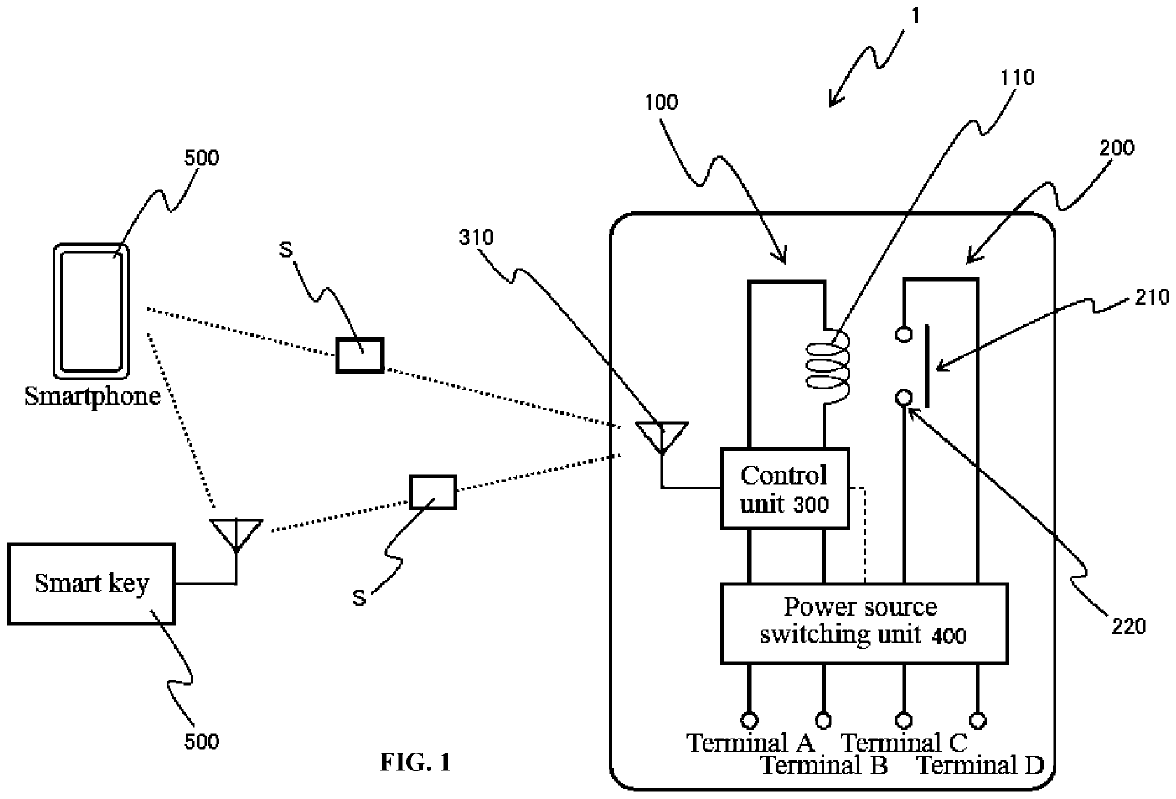

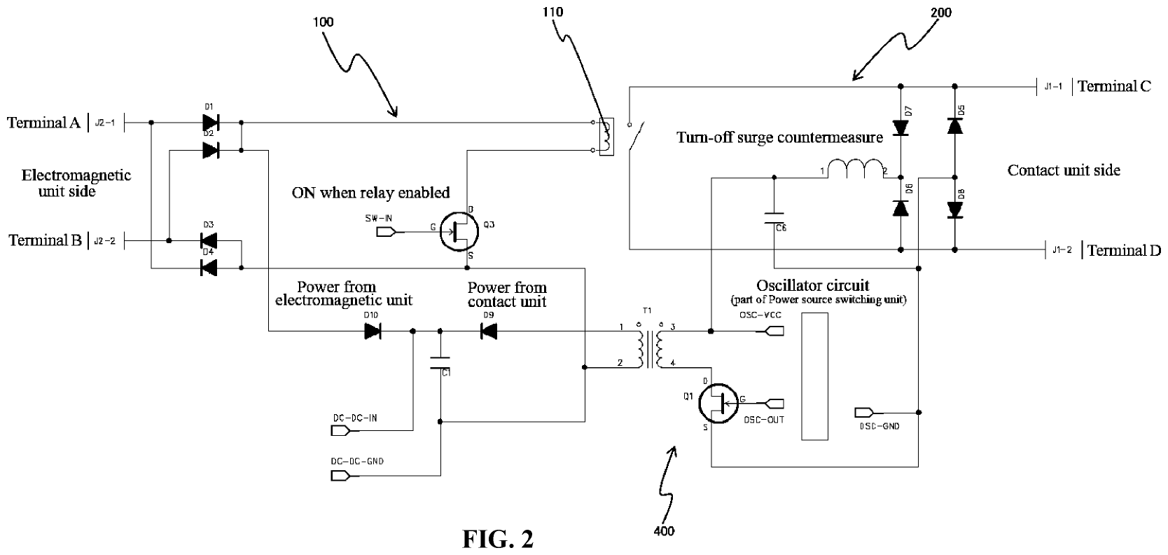

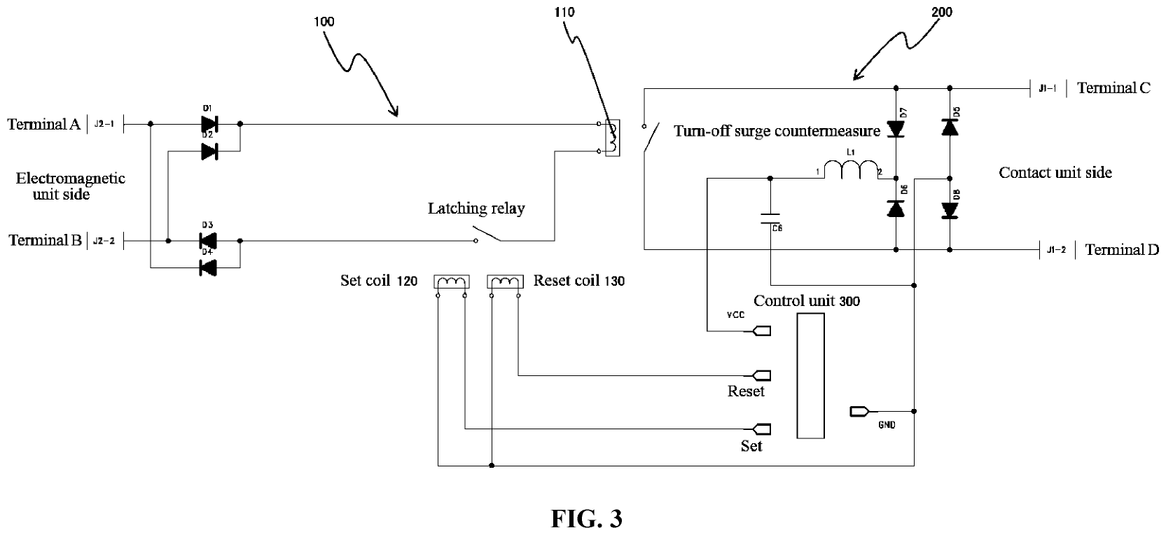

There now follows a detailed explanation of the electromagnetic relay according to the present invention, based on embodiments shown in the drawings. FIG. 1 is a conceptual diagram of the electromagnetic relay according to the present invention and FIG. 2 is a circuit diagram showing how a power source switching operation works. FIG. 3 is a circuit diagram of an electromagnetic relay using a latching structure.

As shown in FIG. 1, an electromagnetic relay 1 of the present invention comprises an electromagnetic unit 100, a contact unit 200, a control unit 300, a power source switching unit 400 and an external device 500, and is an electromagnetic relay having a security feature that by controlling current application to the electromagnetic unit 100 in response to a signal S from the outside enables ON/OFF current switching of the contact unit 200 side.

The electromagnetic unit 100 is a member for current ON/OFF switching of the contact unit 200 side. As shown in FIG. 1, in this embodiment it is equipped with an electromagnet 110 incorporating a coil. The electromagnet 110 is installed between electromagnetic unit 100 side terminals (terminal A and terminal B) and generates magnetic attraction upon passage of current between the terminals.

The contact unit 200 is a member for supplying power to electronic devices. As shown in FIG. 1, in this embodiment it is equipped with a movable contact 210 and fixed contacts 220. The magnetic attraction generated by energizing the electromagnet 110 of the electromagnetic unit 100 draws the movable contact 210 into contact with the fixed contacts 220, whereby contact unit 200 side terminals (terminal C and terminal D) conduct current to supply power to the electronic devices. In addition, the configuration is such that when current to the electromagnetic unit 100 is cut off, contact between the movable contact 210 and fixed contacts 220 is released, thereby cutting off current between the terminals C-D and stopping supply of power to the electronic devices.

As shown in FIG. 1, the electromagnetic relay 1 is configured to comprise the control unit 300. The control unit 300 is a member for controlling current flow between the electromagnetic unit 100 side terminals (terminal A and terminal B). In the present embodiment, the control unit 300 analyzes the signal S upon receiving it from the outside. The control unit 300 analyzes whether the received signal S is an authentic signal and when it finds it to be authentic, starts current flow between the electromagnetic unit 100 side terminals (terminal A and terminal B). This causes the movable contact 210 to contact the fixed contacts 220, whereby activation of the electronic devices is enabled by passage of current between the contact unit 200 side terminals (terminal C and terminal D). In other words, the configuration ensures security by preventing electronic devices equipped with the electromagnetic relay 1 from being activated unless the signal S is authenticated.

As shown in FIG. 1, the electromagnetic relay 1 further comprises the power source switching unit 400. The power source switching unit 400 is a member for ensuring supply of power to the control unit 300. The present embodiment is configured to supply power to the control unit 300 by selecting as the power supplied to the control unit 300 one or the other of, or switching between, the power to the electromagnetic unit 100 (power applied between the electromagnetic unit 100 side terminals) and the power to the contact unit 200 (power applied between the contact unit 200 side terminals).

As shown in FIGS. 1 and 2, in the present embodiment the power source switching unit 400 is connected to both the electromagnetic unit 100 side terminals (terminal A and terminal B) and the contact unit 200 side terminals (terminal C and terminal D). When the electromagnetic unit 100 side terminals (terminal A and terminal B) are de-energized, the power source switching unit 400 acquires power from the contact unit 200 side terminals and supplies the control unit 300 with power for performing its control functions. As the amount of this supplied power is small, the electronic devices that use the electromagnetic relay 1 are not substantially affected.

When the electromagnetic unit 100 side terminals (terminal A and terminal B) are conducting current, power cannot be acquired from the contact unit 200 side terminals. So the power source switching unit 400 supplies the control unit 300 with power for performing its control functions by acquiring power from the electromagnetic unit 100 side terminals.

As the aforesaid configuration enables the power source of the control unit 300 to be selected from or switched between the electromagnetic unit 100 side and the contact unit 200 side, the power source of the control unit 300 can be established without fail.

As shown in FIG. 1, in this embodiment the control unit 300 is configured to comprise a signal receiving unit 310. The signal receiving unit 310 is a member for receiving signals transmitted from an external device 500 such as a smartphone or smart key. Upon receiving an energization request signal from the external device 500, the signal receiving unit 310 analyzes the signal to determine whether to allow energization of the electromagnetic unit 100. The control unit 300 is adapted to respond to authentication of the energization request signal from the external device 500 by performing control to energize the electromagnetic unit 100.

In the present embodiment, the control unit 300 and the external device 500 communicate using Bluetooth (Registered Trademark) encrypted communication, and the control unit 300 and external device 500 are paired to enable authenticated communication, but this is not a limitation and use of configurations utilizing other communication standards such as Wi-Fi is of course also possible.

As the aforesaid configuration prevents communication with the vehicle concerned when, for example, attempting to unlock/lock the vehicle lock or start the vehicle engine without an authenticated smart key or authenticated smartphone, it enables an arrangement that by preventing activation of vehicle internal electronics can totally prevent the vehicle from being operated, thus making vehicle theft prevention and vehicle security easy to achieve. Moreover, the fact that the control unit 300 consumes little power makes anxiety about battery drain unnecessary.

In another possible configuration, the electromagnetic relay 1 is adapted to be constantly monitored by the smart key or the like serving as the external device 500 and, when necessary, operation of the electromagnetic relay 1 is enabled by a smartphone or the like instructing the smart key to transmit an energization request signal to the electromagnetic relay 1. In still another possible configuration, operation of the electromagnetic relay 1 is enabled by the smartphone serving as the external device 500 instructing with respect to the electromagnetic relay 1 direct transmission of an energization request signal to the electromagnetic relay 1. In either case, strong security can be achieved and security that prevents energization in the absence of a signal from an authenticated external device 500 can be ensured.

The electromagnetic relay 1 according to this invention is not limited to the aforesaid use in automobiles but can be applied in equipment of any kind, including machine tools, home appliances and building locking/unlocking systems. Moreover, it enables security capability enhancement simply by replacing existing electromagnetic relays.

As shown in FIG. 3, in the present embodiment the electromagnetic unit 100 can be configured to incorporate a latching mechanism using a set coil 120 and a reset coil 130. A configuration can be adopted whereby energization of the set coil 120 energizes the electromagnetic unit 100, thereby closing the contact unit 200, while energization of the reset coil 130 de-energizes the electromagnetic unit 100, thereby opening the contact unit 200.

When this configuration of the present embodiment is adopted, driving power of the electromagnetic relay 1 is acquired from the contact unit 200 side and energization of the set coil 120 and reset coil 130 is controlled by the control unit 300.

In the present embodiment, if the contact unit 200 side is shorted with connected members in operation upon energization of the electromagnetic unit 100 side, driving power cannot be acquired from the contact unit 200 side. In this case, as shown in FIG. 3, power can be acquired by using the latching mechanism to secure driving power for the electromagnetic relay 1, such as for control by the control unit 300, even in a case where driving power cannot be obtained from the contact unit 200 side.

As another embodiment, it is possible to adopt a configuration in which the electromagnetic unit 100 is equipped with a latching mechanism for controlling open/close of the contact unit 200 by using polarity reversal to energize/de-energize the electromagnetic unit 100. As this configuration obviates the need to constantly supply power to the electromagnetic unit 100 side, it makes it possible to avoid improper power loss of the electronic equipment owing to power loss of the electromagnetic unit 100 side, power deficiency owing to power consumption on the electromagnetic unit 100 side, and so on, and as such, enables provision of an electromagnetic relay 1 particularly convenient for automotive applications.

Moreover, owing to the use of the latching mechanism, opening of the contact unit 200, inter alia, can be controlled by operation of the control unit 300 when opening of the contact unit 200 is disabled owing to power loss.

### EXPLANATION OF SYMBOLS

100 Electromagnetic unit
110 Electromagnet
120 Set coil
130 Reset coil
200 Contact unit
210 Movable contact
220 Fixed contact
300 Control unit
310 Signal receiving unit
400 Power source switching unit
500 External device
S Signal

1-4. (canceled)

5. An electromagnetic relay comprising:
an electromagnetic unit comprising an electromagnet, and a contact unit that contacts or separates a movable contact and fixed contacts depending on energization state of the electromagnet;
a control unit, after receiving a signal from outside and analyzing the received signal, configured to determine permissibility of energization of the electromagnetic unit based on the analysis result;
a power source switching unit configured to supply power to the control unit by selecting one or other of, or switching between, power to the electromagnetic unit and power to the contact unit;
wherein the control unit comprises a signal receiving unit to receive a signal from an external device and the electromagnetic unit is energized after the signal receiving unit determines the permissibility of energization of the electromagnetic unit upon receiving and analyzing an energization request signal from the external device, and
wherein the power source switching unit is configured to connect to both side terminals of the electromagnetic unit side terminals and side terminals of the contact unit; and in order to ensure supply of power to the control unit, when the side terminals of the electromagnetic unit are de-energized, the power source switching unit acquires power from the side terminals of the contact unit and supplies the control unit with power to perform its control functions, and when the side terminals of the electromagnetic unit are energized, the power source switching unit acquires power from the side terminals of the electromagnetic unit and supplies the control unit with power for performing its control functions.

6. The electromagnetic relay of claim 5, wherein the electromagnetic unit and the contact unit are electrically isolated.

7. An electromagnetic relay comprising:
an electromagnetic unit comprising an electromagnet, a latching mechanism equipped with a set coil and a reset coil, and a contact unit that contacts or separates a movable contact and fixed contacts depending on energization state of the electromagnet;
a control unit, after receiving a signal from outside and analyzing the received signal, configured to determine permissibility of energization of the electromagnetic unit based on the analysis result;
a power source switching unit configured to supply power to the control unit by selecting one or other of, or switching between, power to the electromagnetic unit and power to the contact unit; and
wherein the electromagnetic unit is energized to close the contact unit by energization of the set coil and the electromagnetic unit is de-energized to open the contact unit by energization of the reset coil.

8. The electromagnetic relay of claim 7, wherein the electromagnetic unit and the contact unit are electrically isolated.

9. An electromagnetic relay comprising:
an electromagnetic unit comprising an electromagnet, a latching mechanism equipped with a set coil and a reset coil, and a contact unit that contacts or separates a movable contact and fixed contacts depending on energization state of the electromagnet;
a control unit, after receiving a signal from outside and analyzing the received signal, configured to determine permissibility of energization of the electromagnetic unit based on the analysis result;
a power source switching unit configured to supply power to the control unit by selecting one or other of, or switching between, power to the electromagnetic unit and power to the contact unit; and
wherein the electromagnetic unit comprises a latching mechanism to control open/close of the contact unit by performing a polarity reversal to energize/de-energize the electromagnetic unit.

10. The electromagnetic relay of claim 9, wherein the electromagnetic unit and the contact unit are electrically isolated.
